(19) United States
(12) Patent Application Publication
(10) Pub. No.: US 2023/0075536 A1
(43) Pub. Date: Mar. 9, 2023

(54) LITHIUM METAL SECONDARY BATTERY

(71) Applicant: HONDA MOTOR CO., LTD., Tokyo (JP)

(72) Inventor: Kazuki SAIMEN, Saitama (JP)

(21) Appl. No.: 17/822,800

(22) Filed: Aug. 29, 2022

(30) Foreign Application Priority Data
Aug. 31, 2021 (JP) 2021-141893

(51) Int. Cl. H01M 4/62; H01M 10/0525; H01M 10/0585; H01M 4/38; H01M 4/40

(52) U.S. Cl. CPC H01M 4/62; H01M 10/0525; H01M 10/0585; H01M 4/382; H01M 4/405; H01M 2004/027

(57) ABSTRACT

There is provided a lithium metal secondary battery including a positive electrode, a negative electrode, and a solid electrolyte layer between the positive electrode and the negative electrode, the negative electrode including a negative electrode current collector and a protective layer, and the protective layer including a metal capable of being alloyed with lithium and having a volumetric capacity density of 1000 mAh/L or more.

This application is based on and claims the benefit of priority from Japanese Patent Application 2021-141393, filed on 31 Aug. 2021, the content, of which is incorporated herein by reference.

### BACKGROUND OF THE INVENTION

### Field of the Invention

The present invention relates to a lithium metal secondary battery.

### Related Art

Rapid diffusion of portable information-related and communication devices and reduction of CO₂ emissions have prompted development of lithium metal secondary batteries for use in electric and hybrid vehicles.

A lithium metal secondary battery that includes a negative electrode including a negative electrode current collector; a positive electrode; and a solid electrolyte layer has been known (see Patent Document 1).

Patent Document 1: Japanese Unexamined Patent

### SUMMARY OF THE INVENTION

However, when charging a lithium metal secondary battery, lithium metal segregates between a negative electrode current collector and a solid electrolyte layer, causing a lithium metal dendrite to grow. As a result, the solid electrolyte layer cracks or the negative electrode current collector delaminates, which reduces durability of the lithium metal secondary battery.

An object of the present invention is to provide a lithium metal secondary battery with improved durability.

One aspect of the present invention relates to a lithium metal secondary battery including a positive electrode, a negative electrode, and a solid electrolyte layer between the positive electrode and the negative electrode, the negative electrode including a negative electrode current collector and a protective layer, and the protective layer including a metal capable of being alloyed with lithium and having a volumetric capacity density of 1000 mAh/L or more.

The protective layer may further include an alloy of lithium and the metal capable of being alloyed with lithium.

The negative electrode may further include a lithium-metal layer between the negative electrode current collector and the protective layer.

The negative electrode current collector may have a ten-point average roughness (Rz) of 1.0 μm or more and 3.0 μm or less.

In the protective layer, the metal capable of being alloyed with lithium may be one or more selected from the group consisting of antimony, bismuth, and tin.

The protective layer may have a thickness of 0.2 μm or more and 5 μm or less when fully charged.

The present invention can provide a lithium metal secondary battery with improved durability.

### BRIEF DESCRIPTION OF THE DRAWINGS

FIG. 1 is a cross-sectional view showing one exemplary lithium metal secondary battery according to the present embodiment;

FIG. 2 is a cross-sectional view showing another exemplary lithium metal secondary battery according to the present embodiment;

FIG. 3 is a cross-sectional view showing a lithium-ion battery in which a zinc-plated layer is formed instead of a protective layer;

FIG. 4 is a graph showing one exemplary relationship between voltage and charging capacity of the lithium metal secondary battery according to the present embodiment;

FIG. 5 is a graph showing one exemplary relationship between voltage and a charging capacity of a lithium-ion battery that does not include a protective layer;

FIG. 6 is a cross-sectional SEM image of the all-solid lithium metal secondary battery of Example 1 when fully charged; and

FIG. 7 is a cross-sectional SEM image of the all-solid lithium metal secondary battery of Comparative Example 2 when fully charged.

### DETAILED DESCRIPTION OF THE INVENTION

Embodiments of the present invention will be described with reference to drawings.

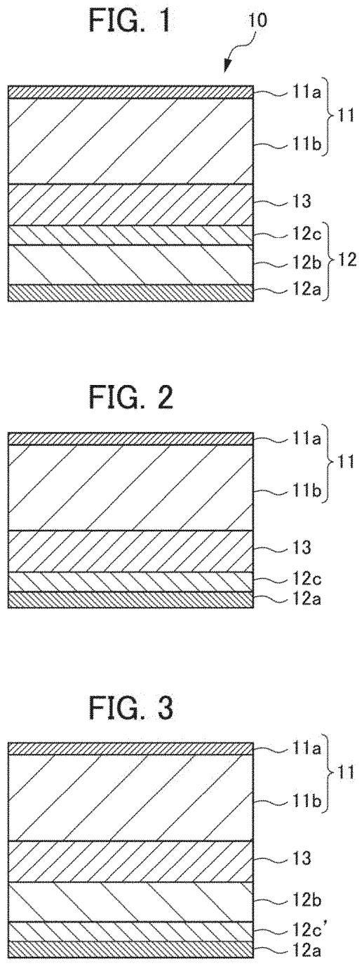

FIG. 1 shows one exemplary lithium metal secondary battery according to the present embodiment.

A lithium metal secondary battery 10 includes a solid electrolyte layer 13 between a positive electrode 11 and a negative electrode 12. Here, the positive electrode 11 includes a positive electrode current collector 11a and a positive electrode composite layer 11b. Furthermore, the negative electrode 12 includes a negative electrode current collector 12a, a lithium-metal layer 12b, and a protective layer 12c. The protective layer 12c includes a metal capable of being alloyed with lithium and has a volumetric capacity density of 1000 mAh/L or more. When the protective layer 12c has a volumetric capacity density of less than 1000 mAh/L, the lithium metal secondary battery 10 has lower durability.

In the lithium metal secondary battery 10, lithium metal is deposited on the negative electrode 12 when charged and a lithium ion is eluted from the negative electrode 12 when discharged. Therefore, in the lithium metal secondary battery 10, the negative electrode 12 may or may not include the lithium-metal layer 12b in the initial state (see FIG. 2). In this case, the lithium metal secondary battery 10 is charged before the lithium metal secondary battery 10 is used. Thus, the metal capable of being alloyed with lithium is alloyed with lithium and expands, so that the protective layer 12c is delaminated from the negative electrode current collector 12a. As a result, the lithium metal is deposited between the negative electrode current collector 12a and the protective layer 12c to thereby form the lithium-metal layer 12b. Therefore, a lithium metal dendrite is prevented from growing and a surface of the solid electrolyte layer 13 is protected by the protective layer 12c.

Meanwhile, for example, when a zinc-plated layer 12c′ is formed on the negative electrode current collector 12a, the lithium-metal layer 12b is deposited from a surface of the zinc-plated layer 12c′ since the zinc-plated layer 12c′ has high adherence to the negative electrode current collector 12a and has electron conductivity (see FIG. 3). In other words, the surface of the solid electrolyte layer 13 is not protected by the zinc-plated layer 12c′. Here, the zinc-plated layer 12c′ has a volumetric capacity density of less than 1000 mAh/L.

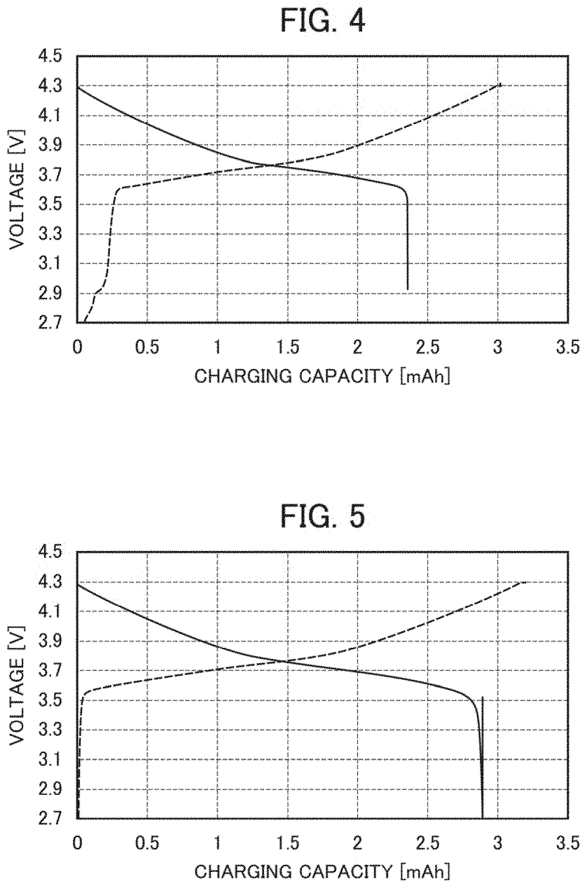

Here, the volumetric capacity density of the protective layer 12c is calculated by dividing charging capacity of the lithium metal secondary battery 10 when a voltage reaches 3.5 V at the initial charge by volume of the protective layer 12c after charge and discharge (see FIG. 4) . Note that, if the lithium metal secondary battery 10 does not include the protective layer 12c, almost no capacity is developed even when the voltage reaches 3.5 V at the initial charge (see FIG. 5). Furthermore, the volume of the protective layer 12c is calculated by multiplying a thickness of the protective layer 12c when fully charged as described below by a projected area of the negative electrode current collector 12a.

Note that, in the initial state, the protective layer 12 may be a layer consisting of the metal capable of being alloyed with lithium (e.g., plated layer) or a layer further including the alloy of lithium and the metal capable of being alloyed with lithium.

The metal capable of being alloyed with lithium is not particularly limited as long as the protective layer 12c has a volumetric capacity density of 1000 mAh/L or more. Examples thereof include antimony, bismuth, and tin. Two or more thereof may also foe used in combination.

The protective layer 12c may include an alloy of a metal other than lithium and the metal capable of being alloyed with lithium.

The alloy of the metal other than lithium and the metal capable of being alloyed with lithium is not particularly limited as long as the protective layer 12c has a volumetric capacity density of 1000 mAh/L or more. Examples thereof include Cu₆Sn₅, Cu₂Sb, SnSb, and SbBi.

The thickness of the protective layer 12c when fully charged is preferably 0.2 μm or more and 5 μm or less and further preferably 1 μm or more and 3 μm or less, When the protective layer 12c has a thickness of 0.2 μm or more and 5 μm or less when fully charged, the lithium metal secondary battery 10 has improved durability.

The negative electrode current collector 12a has preferably a ten-point average roughness(Rz) of 1.0 μm or more and 3.0 μm or less and further preferably 1.5 μm or more and 2.5 μm or less. When the negative electrode current collector 12a has a ten-point average roughness (Rz) of 1.0 μm or more, the lithium metal to be deposited on the negative electrode current collector 12a can be easily retained. When the negative electrode current collector 12a has a ten-point average roughness(Rz) of 3.0 μm or less, the solid electrolyte layer 13 becomes less fragile. Therefore, when the negative electrode current collector 12a has a ten-point; average roughness(Rz) of 1.0 μm or more and 3.0 μm or less, the lithium metal secondary battery 10 has improved durability.

The negative electrode current collector 12a is not particularly limited. Examples thereof include copper foil and the like.

A thickness of the negative electrode current collector 12a is not particularly limited. Examples thereof include 6 μm or more and 18 μm or less.

A relative density of the lithium-metal layer 12b when fully charged is preferably 60% or more and further preferably 65% or more. When the relative density of the lithium-metal layer 12b when fully charged is 60% or more, the lithium metal secondary battery 10 has improved durability.

Here, the relative density of the lithium-metal layer 12b when fully charged is calculated by the following expressions:

(Relative density of lithium-metal layer 12b when fully charged [%])=(Theoretical deposition thickness of lithium metal [μm])/(Maximum thickness of lithium-metal layer 12b when fully charged [μm])×100

(Theoretical deposition thickness of lithium metal [μ])=(Remaining capacity of negative electrode 12 when fully charged [mAh])/(Theoretical capacity density of lithium metal [mAh/g])/(Theoretical density of lithium metal [g/cm³])/(Projected area of negative electrode current collector 12a [cm²])×10⁴

(Remaining capacity of negative electrode 12 when fully charged [mAh])=(Charging capacity at initial charge [mAh])−(Capacity when voltage reaches 3.5 V at initial charge [mAh])

A thickness of the lithium-metal layer 12b is not particularly limited. Examples thereof include 5 μm or more and 50 μm or less.

A method for producing the negative electrode 12 is not particularly limited. Examples thereof include a method of plating the negative electrode current collector 12a with the metal capable of being alloyed with lithium, and the like.

The positive electrode current collector 11a is not particularly limited. Examples thereof include aluminum foil, and the like.

A thickness of the positive electrode current collector 11a is not particularly limited. Examples thereof include 10 μm or more and 20 μm or less.

The positive electrode composite layer lib includes a positive electrode active material and may further include other components.

The positive electrode active material is not particularly limited as long as it can occlude and release a lithium ion. Examples thereof include lithium composite oxide and the like.

The lithium composite oxide is not particularly limited. Examples thereof include LiCoO₂, Li(Ni_{5/10}Co_{2/10}Mn_{3/10})O₂, Li(Ni_{6/10}Co_{2/10}Mn_{2/10}) O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂LiCoO₄, LiMn₂O₄, LiNiO₂, and LiFePO₄. Two or more thereof may also be used in combination.

An amount of the positive electrode active material contained in the positive electrode composite layer 11b is not particularly limited. Examples thereof include 70% by mass or more and 85% by mass or less.

Examples of the other components include a solid electrolyte, a conductive aid, and a binder.

A thickness of the positive electrode composite layer 11b is not particularly limited. Examples thereof Include 70 μm or more and 90 μm or less.

The solid electrolyte constituting the solid electrolyte layer 13 is not particularly limited as long as it has lithium ion conductivity. Examples thereof include oxide electrolyte and sulfide electrolyte. Among them, the sulfide electrolyte is preferred since it has reactivity with the lithium metal and thus increases an effect of the protective layer 12c.

A thickness of the solid electrolyte layer 13 is not particularly limited. Examples thereof include 15 μm or more and 100 μm or less.

Note that, the lithium metal secondary battery 10 may be produced using a known method.

Embodiments of the present invention have been described above, but the present invention is not limited to the above embodiments and the embodiments may be modified as appropriate within the scope of the invention.

### EXAMPLES

Although Examples of the present invention will be described hereafter, the present invention is not limited to the Examples.

### Production of Negative Electrode

Three types of negative electrode current collectors having different ten-point, average roughnesses (Rz) (Table 1) were prepared. Here, the negative electrode current collector was measured for the Rz using a digital microscope VHX (manufactured by KEYENCE CORPORATION).

TABLE 1

| Negative electrode | | |
|---|---|---|
| current collector | Type | Rz [μm] |
| A | Rolled copper foil | 1.0 |
| B | Electrolytic copper foil | 2.5 |
| C | Electrolytic copper foil | 1.7 |

Next, the negative electrode current collector was plated so as to form a protective layer (plated layer) having a predetermined thickness and coating weight (see Table 2) to thereby obtain a negative electrode. Here, the thickness of the protective layer is an average of measurement, values at five points on a cross-sectional SEM image of the negative electrode. Furthermore, the coating weight of the protective layer was quantified by an TCP emission spectral analysis.

TABLE 2

| | | Protective layer | | |
|---|---|---|---|---|
| | Negative electrode | Metal | Thickness | Coating weight |
| | current collector | species | [μm] | [mg/cm²] |
| 1 | B | Sn | 1.5 | 0.9 |
| 2 | A | Sb | 0.5 | 0.3 |
| 3 | B | Sb | 0.6 | 0.3 |
| 4 | C | Sb | 0.4 | 0.1 |
| 5 | B | Sb | 2.4 | 1.1 |
| 6 | B | Bi | 1.3 | 1.1 |
| 7 | B | Bi | 0.06 | 0.06 |
| 8 | A | Zn | 2.4 | 1.1 |
| 9 | B | Zn | 2.3 | 1.1 |

### Examples 1 to 7, Comparative Examples 1 to 3

The below-mentioned steps were performed in an Ar atmosphere glove box having a dew point of −70° C and an oxygen concentration of 1 ppm or less.

### Production of Positive Electrode

Li (Ni_{0.6}Co_{0.2}Mn_{0.2})O₂ serving as a positive electrode active material, thio-LISICON (Li_{3.25}Ge_{0.25}P_{0.75}S₄) serving as a solid electrolyte, acetylene black serving as a conductive aid, styrene-butadiene rubber (SBK) serving as a binder, and butyl butyrate serving as a solvent were charged into a planetary mixer, stirred at 2000 rpm for 3 minutes, and then degassed for 1 minute. Thus, a coating liquid for a positive electrode composite layer was produced. In this case, a mass ratio of the positive electrode active material, the solid electrolyte, the conductive aid, and the binder was 75:22:3:3.

The coating liquid tor a positive electrode composite layer was casted on an aluminum foil serving as a positive electrode current collector, heated to 60° C to remove the solvent, and then roll-pressed to thereby form a positive electrode composite layer having a density of 3.1 g/cc and a coating weight of 26 mg/cm². Thus, a positive electrode was obtained.

### Production of Solid Electrolyte Layer

The thio-LISICON (Li_{3.25}Ge_{0.25}P_{0.75}S₄) serving as the solid electrolyte was compacted at a compacting pressure of 150 MPa using a zirconium tube having a diameter of 10 mm to thereby obtain a solid electrolyte layer having a diameter of 10 mm.

### Production of All-solid Lithium Metal Secondary Battery

The solid electrolyte layer was sandwiched between the positive electrode having a diameter of 10 mm and the negative electrode having a diameter of 10 mm (see Table 3) and pressured at a molding pressure of 1000 MPa to thereby join an interface between the protective layer and the solid electrolyte layer and an interface between the positive electrode composite layer and the solid electrolyte layer. Thus, an all-solid lithium metal secondary battery was obtained. Note that, in Comparative Example 1, a negative electrode current collector A on which the protective layer had not formed was used as the negative electrode.

### Initial Capacity and Initial Resistance

The all-solid lithium metal secondary battery was subjected to three cycles of a constant current (CC)—constant voltage (CV) charge and a CC discharge. A discharge capacity in the first cycle was determined as an initial capacity. Here, the CC charge and the CC discharge in the first and second cycles were performed at 60° C and 0.3 mA. Furthermore, the CV charge was performed for 1 hour after a voltage reached 4.3 V. A discharge final voltage was set so that a Li ion was not released from the protective layer (see Table 3). In the third cycle, the CC-CV charge was performed in the same manner as in the first and second cycles and then initial resistance was measured in a thermostat bath at 60° C by an alternating-current impedance method. Here, the initial resistance was determined as a resistance value on a real axis at a frequency of 1×10⁵ Hz.

### Capacity After Durability and Resistance After Durability

After the initial resistance was measured, the CC discharge and the CC-CV charge were performed in the same manner as in the first and second cycles and a discharge capacity in the tenth cycle was determined as a capacity durability. Furthermore in the eleventh cycle resistance after durability was measured in the same manner as in the third cycle.

A capacity maintenance rate and a resistance increase rate were calculated by the following expressions:

Capacity maintenance rate [%]=(Capacity after durability)/(Initial capacity)×100

Resistance increase rate [%]=(Resistance after durability)/(Initial resistance)×100

### Thickness of Protective Layer When Fully Charged

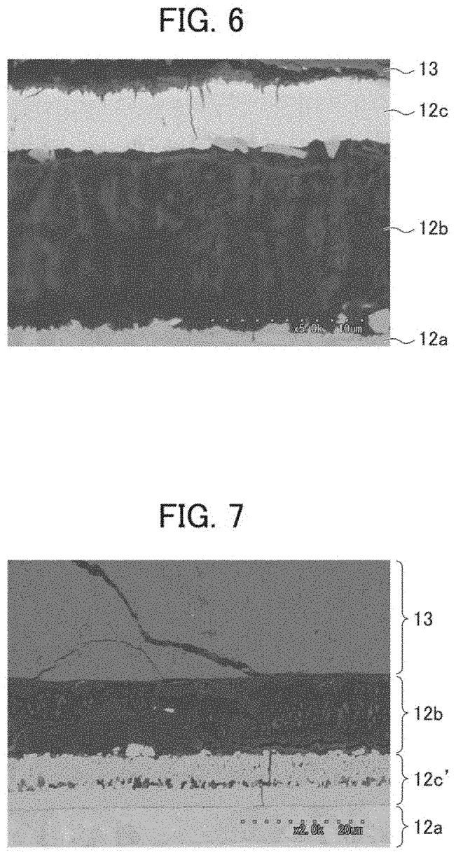

A thickness of the protective layer when fully charged was determined based on a cross-sectional SEM image of the all-solid lithium metal secondary battery when fully charged of which the resistance after durability had been measured (see FIGS. 6 and 7). Here, the thickness of the protective layer when fully charged is an average of measurement values at five points on the cross-sectional SEM image.

### Volumetric Capacity Density of Protective Layer

A volumetric capacity density of the protective layer was calculated by dividing charging capacity when the voltage in the first cycle of the CC-CV charge reached 3.5 V by volume of the protective layer after the charge and discharge cycle was performed. Here, the volume of the protective layer was calculated by multiplying the thickness of the protective layer when fully charged by a projected area of the negative electrode current collector.

### Relative Density of Lithium-metal Layer When Fully Charged

The maximum thickness of the lithium-metal layer when fully charged was determined based on a cross-sectional SEM image of the all-solid lithium metal secondary battery when fully charged of which the resistance after durability had been measured (see FIGS. G and 7). Next, a relative density of the lithium-metal layer when fully charged was calculated by the following expressions:

(Relative density of lithium-metal layer when fully charged [%])=(Theoretical deposition thickness of lithium metal [μm])/(Maximum thickness of lithium-metal layer when fully charged [μm])×100

(Theoretical deposition thickness of lithium metal [μm])=(Remaining capacity of negative electrode when fully charged [mAh])/(Theoretical capacity density of lithium metal [mAh/g])/(Theoretical density of lithium metal [g/cm³])/(Projected area of negative electrode current collector [cm²])×10⁴

(Remaining capacity of negative electrode when fully charged [mAh])−(Charging capacity in first cycle [mAh])−(Capacity when voltage reaches 3.5 V in first cycle of CC-CV charge [mAh])

Table 3 shows evaluation results of the initial capacity, initial resistance, the capacity after durability, the resistance after durability, the capacity maintenance rate, and the resistance increase rate of the all-solid lithium metal secondary battery.

TABLE 3

| | | | | | Capacity | Resistance | Capacity | Resistance |
|---|---|---|---|---|---|---|---|---|
| | | Discharge | Initial | Initial | after | after | maintenance | increase |
| | Negative | final voltage | capacity | resistance | durability | durability | rate | rate |
| | electrode | [V] | [mAh] | [mΩcm²] | [mAh] | [mΩcm²] | [%] | [%] |
| Example 1 | 1 | 3.2 | 2.8 | 6.2 | 1.5 | 7.4 | 54 | 119 |
| Example 2 | 2 | 3.2 | 2.5 | 6.6 | 1.6 | 8.0 | 65 | 114 |
| Example 3 | 3 | 3.2 | 2.3 | 3.9 | 1.5 | 4.7 | 66 | 122 |
| Example 4 | 4 | 3.2 | 2.7 | 5.4 | 1.4 | 7.0 | 53 | 130 |
| Example 5 | 5 | 3.2 | 2.1 | 7.4 | 1.1 | 9.0 | 53 | 121 |
| Example 6 | 6 | 3.2 | 2.4 | 7.3 | 1.4 | 9.0 | 58 | 123 |
| Example 7 | 7 | 3.2 | 2.7 | 5.3 | 1.4 | 6.9 | 52 | 130 |
| Comparative | — | 2.7 | 3.9 | 5.2 | 1.3 | 9.0 | 34 | 179 |
| Example 1 | | | | | | | | |
| Comparative | 8 | 3.5 | 2.5 | 8.8 | 1.2 | 1.2 | 46 | 137 |
| Example 2 | | | | | | | | |
| Comparative | 9 | 3.5 | 2.4 | 8.4 | 1.1 | 1.2 | 46 | 143 |
| Example 3 | | | | | | | | |

Table 4 shows evaluation results when fully charged, the volumetric capacity density of the protective layer, and the relative density of the lithium-metal layer when fully charged of the thickness of the all-solid lithium metal secondary battery.

TABLE 4

| | Thickness of | Volumetric | Relative density of |
|---|---|---|---|
| | protective layer | capacity | lithium-metal layer |
| | when fully | density of | when fully |
| | charged | protective layer | charged |
| | [μm] | [mAh/L] | [%] |
| Example 1 | 2.6 | 2297 | 68.2 |
| Example 2 | 1.6 | 1759 | 70.0 |
| Example 3 | 1.8 | 1797 | 67.3 |
| Example 4 | 1.3 | 1743 | 64.8 |
| Example 5 | 5.0 | 1019 | 67.5 |
| Example 6 | 3.5 | 1648 | 67.0 |
| Example 7 | 0.2 | 1082 | 64.7 |
| Comparative | — | — | 48.9 |
| Example 1 | | | |
| Comparative | 5.1 | 749 | 62.6 |
| Example 2 | | | |
| Comparative | 5.3 | 841 | 60.7 |
| Example 3 | | | |

Tables 3 and 4 demonstrate that the all-solid lithium metal secondary batteries of Examples 1 to 7 have high capacity maintenance rates and low resistance increase rates, that is, high durability.

Meanwhile, the all-solid lithium metal secondary battery of Comparative Example 1 has a higher initial capacity, but lower durability since the protective layer is not formed on the negative electrode and the lithium ion is not alloyed. The all-solid lithium metal secondary batteries of Comparative Examples 2 and 3 have volumetric capacity densities of the protective layers of 749 mAh/L and 841 mAh/L, respectively, which results in the formation of lithium-metal layers between the protective layers and the solid electrolyte layers and thus decreases durability. Here, the low volumetric capacity density of the protective layer and the low relative density of the lithium-metal layer when fully charged also suggest that a lithium-metal layer was formed between the protective layer and the solid electrolyte layer.

### EXPLANATION OF REFERENCE NUMERALS

10 Lithium-metal secondary battery

11 Positive electrode

11a Positive electrode current collector

11b Positive electrode, composite layer

12 Negative electrode

12a Negative electrode current collector

12b Lithium-metal layer

12c Protective layer

13 Solid electrolyte layer

What is claimed is:

1. A lithium metal secondary battery, comprising:
a positive electrode;
a negative electrode; and
a solid electrolyte layer between the positive electrode and the negative electrode,
the negative electrode comprising a negative electrode current collector and a protective layer, and
the protective layer comprising a metal capable of being alloyed with lithium and having a volumetric capacity density of 1000 mAh/L or more.

2. The lithium metal secondary battery according to claim 1, wherein the protective layer further comprises an alloy of lithium and the metal capable of being alloyed with lithium.

3. The lithium metal secondary battery according to claim 1, wherein the negative electrode further comprises a lithium-metal layer between the negative electrode current collector and the protective layer.

4. The lithium metal secondary battery according to claim 1, wherein the negative electrode current collector has a ten-point average roughness (Rz) of 1.0 μm or more and 3.0 μm or less.

5. The lithium metal secondary battery according to claim 1, wherein the metal capable of being alloyed with lithium is one or more selected from the group consisting of antimony, bismuth, and tin.

6. The lithium metal secondary battery according to claim 1, wherein the protective layer has a thickness of 0.2 μm or more and 5 μm or less when fully charged.
